(19) United States
(12) Patent Application Publication
(10) Pub. No.: US 2003/0191764 A1
(43) Pub. Date: Oct. 9, 2003

(54) System and method for acoustic fingerpringting

(76) Inventor: Isaac Richards, Willoughby, OH (US)

Correspondence Address: Edward J Kondracki, Miles & Stockbridge, Suite 500, 1751 Pinnacle Drive, McLean, VA, 22102-3833, US

(21) Appl. No.: 10/203,073

(22) PCT Filed: Mar. 13, 2002
(86) PCT No.: PCT/US02/07528

(51) Int. Cl. G06F 7/00

(52) U.S. Cl. 707/100

(57) ABSTRACT

A method for quickly and accurately identifying a digital file, specifically one that represents an audio file. The identification can be used for tracking royalty payments to copyright owners. A database stores features of various audio files and a globally unique identifier (GUID) for each file. Advantageously, the method allows a database to be updated in the case of a new audio file by storing its features and generating a new unique identifier for the new file. The file is sampled to generate a fingerprint that is used to determine if the file matched a file stored in the database. Advantageously, any label used for the work is automatically updated if it appears to be in error.

### CROSS-REFERENCE TO RELATED APPLICATION

The present application claims the benefit of U.S. provisional application 60/275,029 filed Mar. 13, 2001 and U.S. application Ser. No. 09/931,859 filed Aug. 20, 2001, both of which are hereby incorporated by reference.

### BACKGROUND OF THE INVENTION

1. Field of the Invention

The present invention is related to a method for the creation of digital fingerprints that are representative of the properties of a digital file. Specifically, the fingerprints represent acoustic properties of an audio signal corresponding to the file. More particularly, it is a system to allow the creation of fingerprints that allow the recognition of audio signals, independent of common signal distortions, such as normalization and psycho acoustic compression.

2. Description of the Prior Art

Acoustic fingerprinting has historically been used primarily for signal recognition purposes, in particular, terrestrial radio monitoring systems. Since these were primarily continuous audio sources, fingerprinting solutions were required which dealt with the lack of delimiters between given signals. Additionally, performance was not a primary concern of these systems, as any given monitoring system did not have to discriminate between hundreds of thousands of signals, and the ability to tune the system for speed versus robustness was not of great importance.

As a survey of the existing approaches, U.S. Pat. No. 5,918,223 describes a system that builds sets of feature vectors, using such features as bandwidth, pitch, brightness, loudness, and MFCC coefficients. It has problems relating to the cost of the match algorithm (which requires summed differences across the entire feature vector set), as well as the discrimination potential inherent in its feature bank. Many common signal distortions that are encountered in compressed audio files, such as normalization, impact those features, making them unacceptable for a large-scale system. Additionally, it is not tunable for speed versus robustness, which is an important trait for certain systems.

U.S. Pat. No. 5,581,658 describes a system which uses neural networks to identify audio content. It has advantages in high noise situations versus feature vector based systems, but does not scale effectively, due to the cost of running a neural network to discriminate between hundreds of thousands, and potentially millions of signal patterns, making it impractical for a large-scale system.

U.S. Pat. No. 5,210,820 describes an earlier form of feature vector analysis, which uses a simple spectral band analysis, with statistical measures such as variance, moments, and kurtosis calculations applied. It proves to be effective at recognizing audio signals after common radio style distortions, such as speed and volume shifts, but tends to break down under psycho-acoustic compression schemes such as mp3 and ogg vorbis, or other high noise situations.

None of these systems proves to be scalable to a large number of fingerprints, and a large volume of recognition requests. Additionally, none of the existing systems are effectively able to deal with many of the common types of signal distortion encountered with compressed files, such as normalization, small amounts of time compression and expansion, envelope changes, noise injection, and psycho acoustic compression artifacts.

### SUMMARY OF THE INVENTION

The present invention provides a method of identifying digital files, wherein the method includes accessing a digital file, determining a fingerprint for the digital file, wherein the fingerprint represents at least one feature of the digital file, comparing the fingerprint to reference fingerprints, wherein the reference fingerprints uniquely identify a corresponding digital file having a corresponding unique identifier, and upon the comparing revealing a match between the fingerprint and one of the reference fingerprints, outputting the corresponding unique identifier for the corresponding digital file of the one of the reference fingerprints that matches the fingerprint.

The present invention also provides a method for identifying a fingerprint for a data file, wherein the method includes receiving the fingerprint having a at least one feature vector developed from the data file, determining a subset of reference fingerprints from a database of reference fingerprints having at least one feature vector developed from corresponding data files, the subset being a set of the reference fingerprints of which the fingerprint is likely to be a member and being based on the at least one feature vector of the fingerprint and the reference fingerprints, and determining if the fingerprint matches one of the reference fingerprints in the subset based on a comparison of the reference fingerprint feature vectors in the subset and the at least one feature vector of the fingerprint.

The invention also provides a method of identifying a fingerprint for a data file, including receiving the fingerprint having a plurality of feature vectors sampled from a data file over a series of time, finding a subset of reference fingerprints from a database of reference fingerprints having a plurality of feature vectors sampled from their respective data files over a series of time, the subset being a set of reference fingerprints of which the fingerprint is likely to be a member and being based on the rarity of the feature vectors of the reference fingerprints, and determining if the fingerprint matches one of the reference fingerprints in the subset.

According to another important aspect of the invention, a method for updating a reference fingerprint database is provided. The method includes receiving a fingerprint for a data file, determining if the fingerprint matches one of a plurality of reference fingerprints, and upon the determining step revealing no match, updating the reference fingerprint database to include the fingerprint.

Additionally, the invention provides a method for determining a fingerprint for a digital file, wherein the method includes receiving the digital file, accessing the digital file over time to generate a sampling, and determining at least one feature of the digital file based on the sampling. The at least one feature includes at least one of the following features: a ratio of a mean of the absolute value of the sampling to root-mean-square average of the sampling; spectral domain features of the sampling; a statistical summary of the normalized spectral domain features; Haar wavelets of the sampling; a zero crossing mean of the sampling; a beat tracking of the sampling; and a mean energy delta of the sampling.

Preferably, a system for acoustic fingerprinting according to the invention consists of two parts: the fingerprint generation component, and the fingerprint recognition component. Fingerprints are built off a sound stream, which may be sourced from a compressed audio file, a CD, a radio broadcast, or any of the available digital audio sources. Depending on whether a defined start point exists in the audio stream, a different fingerprint variant may be used. The recognition component can exist on the same determiner as the fingerprint component, but will frequently be located on a central server, where multiple fingerprint sources can access it.

Fingerprints are preferably formed by the subdivision of an audio stream into discrete frames, wherein acoustic features, such as zero crossing rates, spectral residuals, and Haar wavelet residuals are extracted, summarized, and organized into frame feature vectors. Depending on the robustness requirement of an application, different frame overlap percentages, and summarization methods are supported, including simple frame vector concatenation, statistical summary (such as variance, mean, first derivative, and moment calculation), and frame vector aggregation.

Fingerprint recognition is preferably performed by a Manhattan distance calculation between a nearest neighbor set of feature vectors (or alternatively, via a multi-resolution distance calculation), from a reference database of feature vectors, and a given unknown fingerprint vector. Additionally, previously unknown fingerprints can be recognized due to a lack of similarity with existing fingerprints, allowing the system to intelligently index new signals as they are encountered. Identifiers are associated with the reference database vector, which allows the match subsystem to return the associated identifier when a matching reference vector is found.

Finally, comparison functions can be described to allow the direct comparison of fingerprint vectors, for the purpose of defining similarity in specific feature areas, or from a gestalt perspective. This allows the sorting of fingerprint vectors by similarity, a useful quantity for multimedia database systems.

### BRIEF DESCRIPTION OF THE DRAWINGS

The invention will be more readily understood with reference to the following figures wherein like characters represent like components throughout and in which:

FIG. 1 is a logic flow diagram, illustrating a method for identifying digital files, according to the invention;

FIG. 2 is a logic flow diagram, showing the preprocessing stage of fingerprint generation, including decompression, down sampling, and dc offset correction;

FIG. 3 is a logic flow diagram, giving an overview of the fingerprint generation steps;

FIG. 4 is a logic flow diagram, giving more detail of the time domain feature extraction step;

FIG. 5 is a logic flow diagram, giving more detail of the spectral domain feature extraction step;

FIG. 6 is a logic flow diagram, giving more detail of the beat tracking feature step;

FIG. 7 is a logic flow diagram, giving more detail of the finalization step, including spectral band residual computation, and wavelet residual computation and sorting;

FIG. 8 is a diagram of the aggregation match server components;

FIG. 9 is a diagram of the collection match server components;

FIG. 10 is a logic flow diagram, giving an overview of the concatenation match server logic;

FIG. 11 is a logic flow diagram, giving more detail of the concatenation match server comparison function;

FIG. 12 s a logic flow diagram, giving an overview of the aggregation match server logic;

FIG. 13 is a logic flow diagram, giving more detail of the aggregation match server string fingerprint comparison function;

FIG. 14 is a simplified logic flow diagram of a meta-cleansing technique of the present invention; and

FIG. 15 is a schematic of the exemplary database tables that are utilized in a meta-cleansing process, according to the present invention.

### DETAILED DESCRIPTION OF THE INVENTION

The ideal context of this system places the fingerprint generation component within a database or media playback tool. This system, upon adding unknown content, proceeds to generate a fingerprint, which is then sent to the fingerprint recognition component, located on a central recognition server. The resulting identification information can then be returned to the media playback tool, allowing, for example, the correct identification of an unknown piece of music, or the tracking of royalty payments by the playback tool.

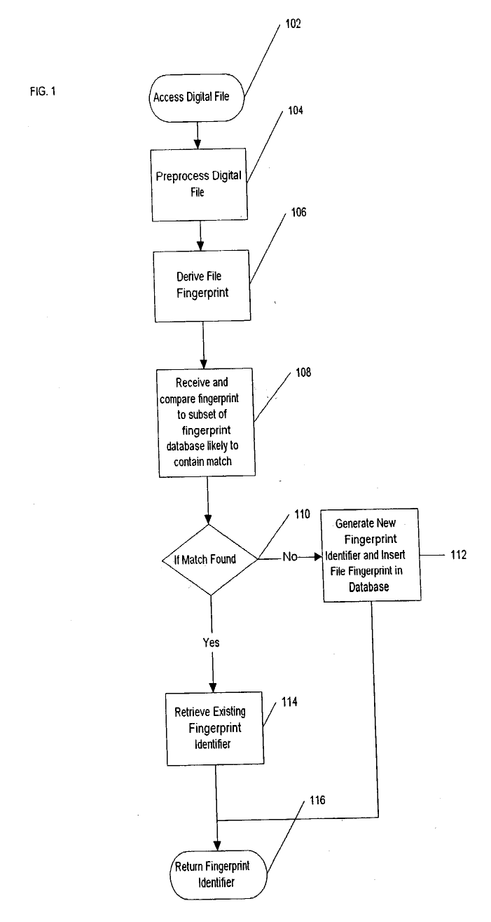

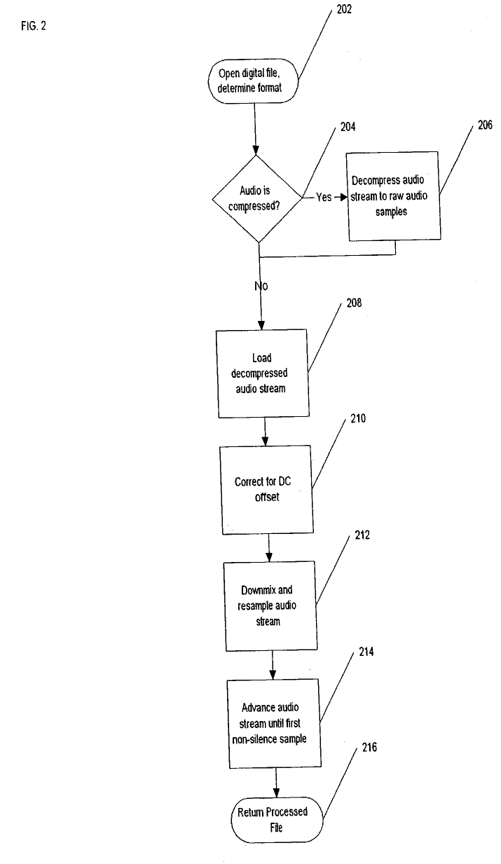

FIG. 1 illustrates the steps of an exemplary embodiment of a method for identifying a digital file according the invention. The process begins at step 102, wherein a digital file is accessed. At step 104, the digital file is preferably preprocessed. The preprocessing allows for better fingerprint generation. An exemplary embodiment of the preprocessing step is set forth in FIG. 2, described below.

At step 106, a fingerprint for the digital file is determined. An exemplary embodiment of this determination is set forth in FIG. 3, described below. The fingerprint is based on features of the file. At step 108, the fingerprint is compared to reference fingerprints to determine if it matches any of the reference fingerprints. Exemplary embodiments of process utilized to determine if there is a match are described below. If a match is found at the determination step 110 an identifier for the reference fingerprint is retrieved at step 112. Otherwise the process proceeds to step 114, wherein a new identifier is generated for the fingerprint. The new identifier may be stored in a database that includes the identifiers for the previously existing reference fingerprints.

After steps 112 and 114 the process proceeds to step 116, wherein the identifier for the fingerprint is returned.

As used herein, “accessing” means opening, downloading, copying, listening to, viewing (for example in the case of a video file), displaying, running (for example, in the case of a software file) or otherwise using a file. Some aspects of the present invention are applicable only to audio files, whereas other aspects are applicable to audio files and other types of files. The preferred embodiment, and the description which follows, relate to a digital file representing an audio file.

FIG. 2 illustrates a method of preprocessing a digital file in preparation for fingerprint generation. The first step 202 is accessing a digital file to determine the file format. Step 204 tests for data compression. If the file is compressed, step 206 decompresses the digital file.

The decompressed digital file is loaded at step 208. The decompressed file is then scanned for a DC offset error at step 210, and if one is detected, the offset is removed. Following the DC offset correction, the digital file, which is various exemplary embodiments is an audio stream, is down sampled at step 212. Preferably, it is resampled at 16 bit samples, 11025 hz and down mixed to mono 11025 hz, which also serves as a low pass filter of the high frequency component of the audio, and is then down mixed to a mono stream, since the current feature banks do not rely upon phase information. This step is performed to both speed up extraction of acoustic features, and because more noise is introduced in high frequency components by compression and radio broadcast, making them less useful components from a feature standpoint. At step 214, this audio stream is advanced until the first non-silent sample. This 11025 hz, 16 bit, mono audio stream is then passed into the fingerprint generation subsystem for the beginning of signature or fingerprint generation at step 216.

Four parameters influence fingerprint generation, specifically, frame size, frame overlap percentage, frame vector aggregation type, and signal sample length. In different types of applications, these can be optimized to meet a particular need. For example, increasing the signal sample length will audit a larger amount of a signal, which makes the system usable for signal quality assurance, but takes longer to generate a fingerprint. Increasing the frame size decreases the fingerprint generation cost, reduces the data rate of the final signature, and makes the system more robust to small misalignment in fingerprint windows, but reduces the overall robustness of the fingerprint. Increasing the frame overlap percentage increases the robustness of the fingerprint, reduces sensitivity to window misalignment, and can remove the need to sample a fingerprint from a known start point, when a high overlap percentage is coupled with a collection style frame aggregation method. It has the costs of a higher data rate for the fingerprint, longer fingerprint generation times, and a more expensive match routine.

In the present invention, two combinations of parameters were found to be particularly effective for different systems. The use of a frame size of 96,000 samples, a frame overlap percentage of zero, a concatenation frame vector aggregation method, and a signal sample length of 288,000 samples prove very effective at quickly indexing multimedia content, based on sampling the first 26 seconds in each file. It is not robust against window shifting, or usable in a system wherein that window cannot be aligned, however. In other words, this technique works where the starting point for the audio stream is known.

For applications where the overlap point between a reference fingerprint and an audio stream is unknown (i.e., the starting point is not known), the use of 32,000 sample frame windows, with a 75% frame overlap, a signal sample length equal to the entire audio stream, and a collection aggregation method should be utilized. The frame overlap of 75 percent means that a frame overlaps an adjacent frame by 75 percent.

Turning now to the fingerprint generation process of FIG. 3, the digital file is received at step 302. Preferably, the digital has been preprocessed by the method illustrated in FIG. 2. At step 304, the transform window size (described below), the window overlap percentage, the frame size, and the frame overlap are set. For example, in one exemplary embodiment, the window size is set to 64 samples, the window percentage is set to 50 percent, the frame size is set to 64 times 4,500 window sizes samples and frame overlap is set to zero percent. This embodiment would be for a concatenation fingerprint described below to 4,500 window size samples.

At step 306, the next step is to advance the audio stream sample one frame size into a working buffer memory. For the first frame, the advance is a full frame size and for all subsequent advances for audio stream, the advance is the frame size times the frame overlap percentage.

Step 308 tests if a full frame was read in. In other words, step 308 is determining whether there is any further audio in the signal sample length. If so, the time domain features of the working frame vector are determined at step 310. FIG. 3, which is described below, illustrates an exemplary method for step 310.

Steps 312 through 320 are conducted for each window, for the current frame, as indicted by the loop in FIG. 3. At step 312, a Haar wavelet transform, with preferably a transform size of 64 samples, using ½ for the high pass and low pass components of the transform, is determined across the all of the windows in the frame. Each transform is preferably overlapped by 50%, and the resulting coefficients are summed into a 64 point array. Preferably, each point in the array is then divided by the number of transforms that have been performed, and the minimum array value is stored as a normalization value. The absolute value of each array value minus the normalization value is then stored in the array, any values less than 1 are set to 0, and the final array values are converted to log space using the equation array[i]=20*log10(array[i]). These log scaled values are then sorted into ascending order, to create the wavelet domain feature bank at step 314.

Subsequent to the wavelet computation, a window function, preferably a Blackman Harris function of 64 samples in length, is applied for each window at step 316. A Fast Fourier transform is determined at step 318 for each window in the frame. The process proceeds to step 320, wherein the spectral domain features are determined for each window. A preferred method for making this determination is set forth in FIG. 5.

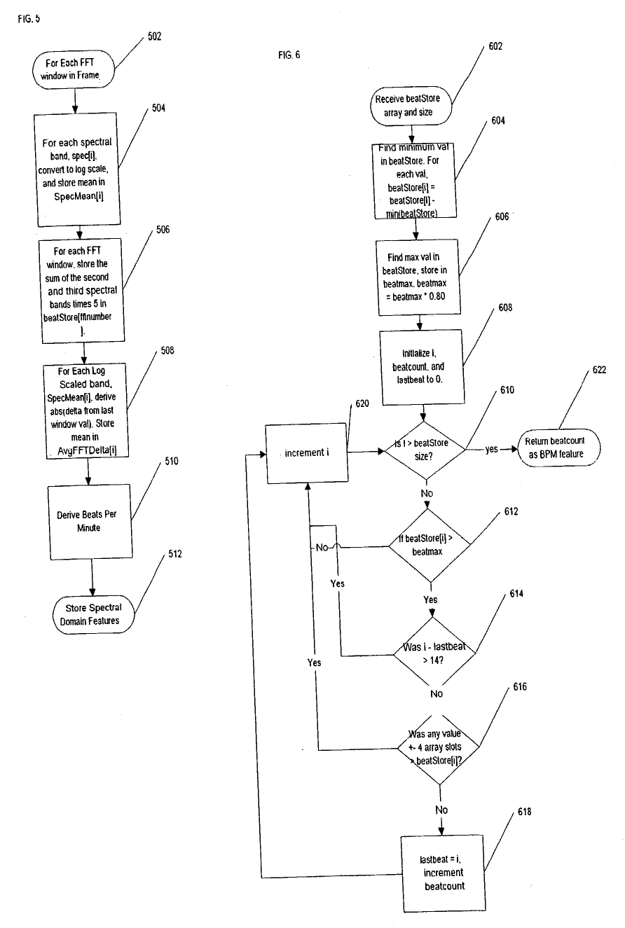

After determining the spectral domain features, the process proceeds to step 322, wherein the frame finalization process is used to cleanup the final frame feature values. A preferred embodiment of this process is described in FIG. 7.

After step 322 the process shown in FIG. 3 loops back to step 306. If in step 308, it is determined that there is no more audio, the process proceeds to step 324, wherein the final fingerprint is saved. In a concatenation type fingerprint, each frame vector is concatenated with all other frame vectors to form a final fingerprint. In an aggregation type fingerprint, each frame vector is stored in a final fingerprint, where each frame vector is kept separate.

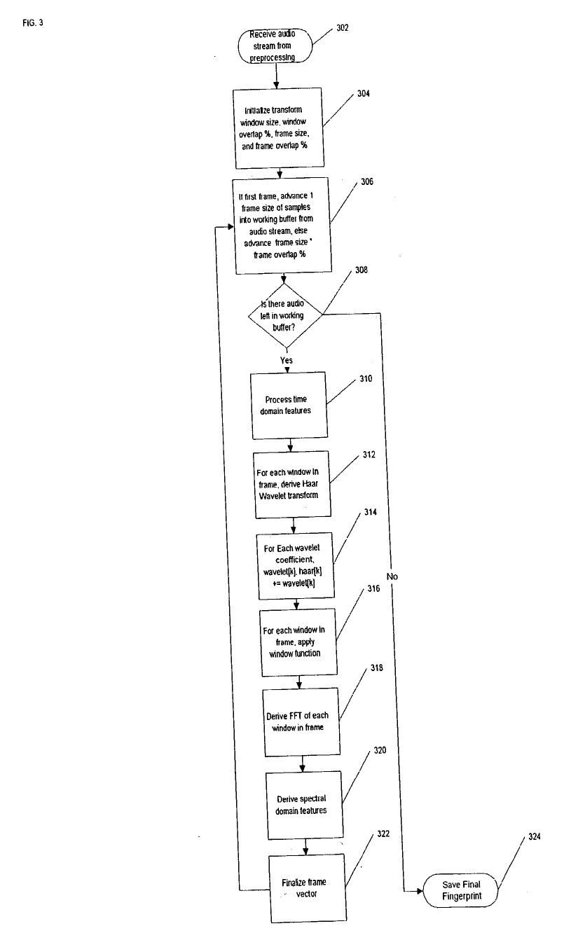

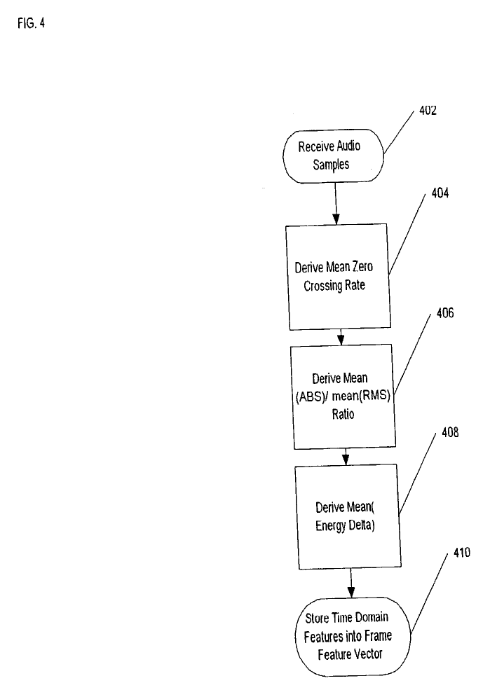

FIG. 4 illustrates an exemplary method for determining the time domain features according to the invention. After receiving the audio samples at step 402, the mean zero crossing rate is determined at step 404 by storing the sign of the previous sample, and incrementing a counter each time the sign of the current sample is not equal to the sign of the previous sample, with zero samples ignored. The zero crossing total is then divided by the frame size, to determine the zero crossing mean feature. The absolute value of each sample is also summed into a temporary variable, which is also divided by the frame size to determine the sample mean value. This is divided by the root-mean-square of the samples in the frame, to determine the mean/RMS ratio feature at step 406. Additionally, the mean energy value is stored for each step of 10624 samples within the frame. The absolute value of the difference from step to step is then averaged to determine the mean energy delta feature at step 408. These features are then stored in a frame feature vector at step 410.

With reference to FIG. 5, the process of determining the spectral domain features begins at step 502, wherein each Fast Fourier transform is identified. For each transform, the resulting power bands are copied into a 32 point array and converted to a log scale at step 504. Preferably, the equation spec[I]=log10(spec[I]/4096)+6 is used to convert each spectral band to log scale. Then at step 506, the sum of the second and third bands, times five, is stored in an array, for example an array entitled beatStore, which is indexed by the transform number. At step 508, the difference from the previous transform is summed in a companion spectral band delta array of 32 points. Steps 504, 506 and 508 are repeated, with the set frame overlap percentage between each transform, across each window in the frame. The process proceeds to step 510, wherein the beats per minute are determined. The beats per minute are preferably determined using the beat tracking algorithm described in FIG. 6, which is described below. After the step 510, the spectral domain features are stored at step 512.

FIG. 6 illustrates an exemplary embodiment for determining beats per minute. At step 602, the beatStore array and the Fast Fourier transform count are received. Then at step 604, the minimum value in the beatStore array is found, and each beatStore value is adjusted such that beatStore[I]=beatStore[I]−minimum val. At step 606, the maximum value in the beatStore array is found, and a constant, beatmax is declared which is preferably 80% of the maximum value in the beatStore array. At step 608, several counters are initialized. For example, the counters, beatCount and lastbeat are set to zero, as well as the counter, i, which identifies the value in the beatStore array being evaluated. Steps 612 through 618 are performed for each value in the beatStore array. At step 610 it is determined if the counter, i, is greater than the beatStore size. If it is not, then the process proceeds to step 612, wherein it is determined if the current value in the beatStore array is greater than the beatmax constant. If not, the counter, i, is incremented by one at step 620. Otherwise, the process proceeds to step 614, wherein it is determined whether there has been more than 14 slots since the last detected beat. If not, the process proceeds to step 620, wherein the counter, i, is incremented by one. Otherwise the process proceeds to step 616, wherein it its determined whether all the beatStore values +−4 array slots are less than the current value. If yes, then the process proceeds to step 620. Otherwise, the process proceeds to step 618, wherein the current index value of the beatStore array is stored as the lastbeat and the beatCount is incremented by one. The process then proceeds to step 620, wherein, as stated above, the counter, i, is incremented by one and the process then loops back to step 610.

FIG. 7 illustrates an exemplary embodiments of a frame finalization process. First, the frame feature vectors are received at step 702. Then at step 704, the spectral power band means are converted to spectral residual bands by finding the minimum spectral band mean. At step 706, the minimum spectral band mean is subtracted from each spectral band mean. Next, at step 708, the sum of the spectral residuals is stored as a spectral residual sum feature. At step 710, the minimum value of all the absolute values of the coefficients in the Haar wavelet array is determined. At step 712, the minimum value is subtracted from each coefficient in the Haar wavelet array. Then at step 714, it is determined which coefficients in the Haar wavelet array are considered to be trivial. Trivial coefficients are preferably modified to a zero value and the remaining coefficients are log scaled, thus generating a modified Haar wavelet array. A trivial coefficient is determined by a cut-off threshold value. Preferably the cut-off threshold value is the value of one. At step 716, the coefficients in the modified Haar wavelet array are sorted in an ascending order. At step 718, the final frame feature vecotr, for this frame, is stored in the final fingerprint. Depending on the type of fingerprint to be determined, aggregation or concatenation, the final frame vector will consist of any or a combination of the following: the spectral residuals, the spectral deltas, the sorted wavelet residuals, the beats feature, the mean/RMS ratio, the zero crossing rate, and the mean energy delta feature.

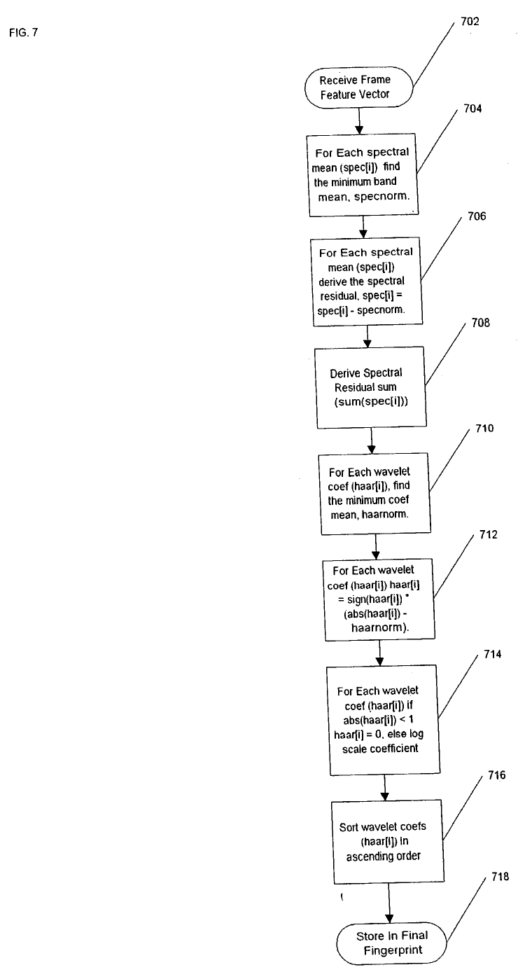

In a preferred system, which is utilized to match subject fingerprints to reference fingerprints, a fingerprint resolution component is located on a central server. However, it should be appreciated that the methods of the present invention can also be used in a distributed system. Depending on the type of fingerprint to be resolved, a database architecture of the server will be similar to FIG. 8 for concatenation type fingerprints, and similar to FIG. 9 for aggregation type fingerprints.

Referring to FIG. 8, a database listing for concatenation system 800 is schematically represented and generally includes a feature vector to fingerprint identifier table 802, a feature class to feature weight bank and match distance threshold table 804 and a feature vector hash index table 806. The identifiers in the feature vectortable 802 are unique globally unique identifiers (GUIDs), which provide a unique identifier for individual fingerprints.

Referring to FIG. 9, a database listing for an aggregation match system 900 is schematically represented and includes a frame vector to subsig ID table 902, a feature class to feature weight bank and match distance threshold table 904 and a feature vector hash index table 906. The aggregation match system 900 also has several additional tables, and preferably a fingerprint string (having one or more feature vector identifiers) to fingerprint identifier table 908, a subsig ID to fingerprint string location table 910 and a subsig ID to occurrence rate table 912. The subsig ID to occurrence rate table 912 shows the overall occurrence rate of any given feature vector for reference fingerprints. The reference fingerprints are fingerprints for data files that the incoming file will be compared against. The reference fingerprints are generated using the fingerprint generation methods described above. In the aggregation system 900, a unique integer or similar value is used in place of the GUID, since the fingerprint string to identifier table 908 contain the GUID for aggregation fingerprints. The fingerprint string table 908 consists of the identifier streams associated with a given fingerprint. The subsig ID to string location database 910 consists of a mapping between every subsig ID and all the string fingerprints that contain a given subsig ID, which will be described further below.

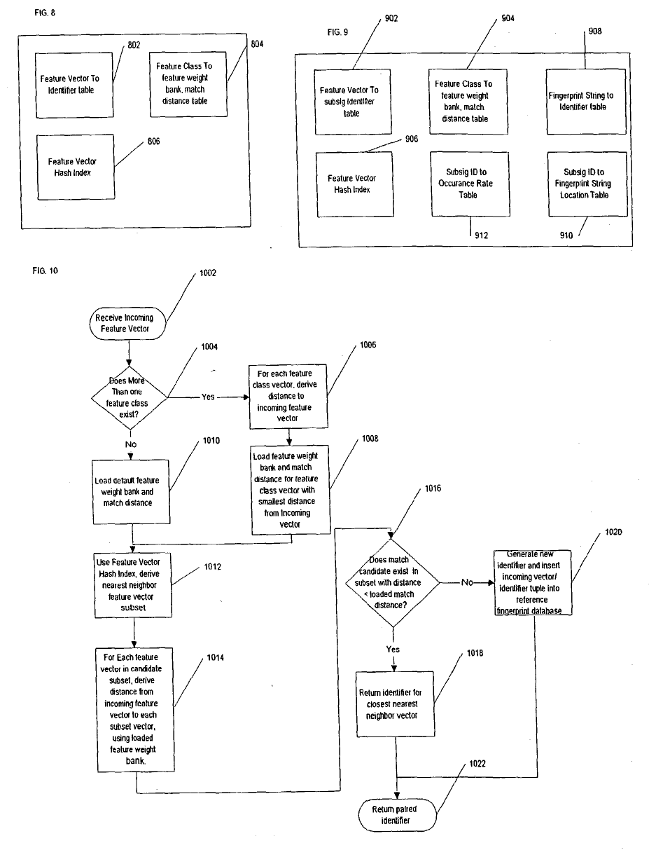

To determine if an incoming concatenation type fingerprint matches a file fingerprint in a database of fingerprints, the match algorithm described in FIG. 10 is used. First, an incoming fingerprint having a feature vector is received at step 1002. Then at step 1004, it is determined if more than one feature class exists for the file fingerprints. Preferably, the number of feature classes is stored in a feature class to feature weight bank, and match distance threshold table, such as table 804. The number of feature classes is preferably predetermined. An example of a feature class is a centroid of feature vectors for multiple samples of a particular type of music. If there are multiple classes, the process proceeds to step 1006, wherein the distance between the incoming feature vector and each feature class vector is determined. For step 1008, a feature weight bank and a match distance threshold are loaded, from, for example, the table 804, for the feature class vector that is nearest the incoming feature vector. The feature weight bank and the match distance threshold are preferably predetermined. Determining the distance between the respective vectors is preferably accomplished by the comparison function set forth in FIG. 11, which will be described below.

If there are not multiple feature classes as determined at step 1004, then the process proceeds to step 1010, wherein a default feature weight bank and a default match distance threshold are loaded, from for example table 804.

Next, at step 1012, using the feature vector database hash index, which subdivides the reference feature vector database based on the highest weighted features in the vector, the nearest neighbor feature vector set of the incoming feature vector is loaded. The process proceeds to step 1014, wherein each feature vector in the nearest neighborhood set, the distance from the incoming feature vector to each nearest neighbor vector is determined using the loaded feature weight bank.

At step 1016, the distances derived in step 1014 are compared with the loaded match distance threshold. If the distance between the incoming feature vector and any of the reference feature vectors of the file fingerprints in the subset are less than the loaded match distance threshold, then the linked GUID for that feature vector is returned at step 1018 as the match for the incoming feature vector. If none of the nearest neighbor vectors are within the match distance threshold, as determined at step 1016, a new GUID is generated, and the incoming feature vector is added to the file fingerprint database at step 1020, as a new file fingerprint. Thus, allowing the system to organically add to the file fingerprint database as new signals are encountered. At step 1022, the GUID is returned.

Additionally, the step of re-averaging the feature values of the matched feature vector can be taken, which consists of multiplying each feature vector field by the number of times it has been matched, adding the values of the incoming feature vector, dividing by the now incremented match count, and storing the resulting means in the reference feature vector in the file fingerprint database entry. This helps to reduce fencepost error, and move a reference feature vector to the center of the spread for different quality observations of a signal, in the event the initial observations were of an overly high or low quality.

FIG. 11 illustrates a preferred embodiment of determining the distance between two feature vectors, according to the invention. At step 1102, a first and second feature vectors are received as well as a feature weight bank vector. At step 1104 the distance between the first and second feature vectors is determined according to the following function: (for the length of first feature vector), distancesum=(abs(vec1[i]−vec2[i]))*weight[i]. Then at step 1106 the summed distance is returned.

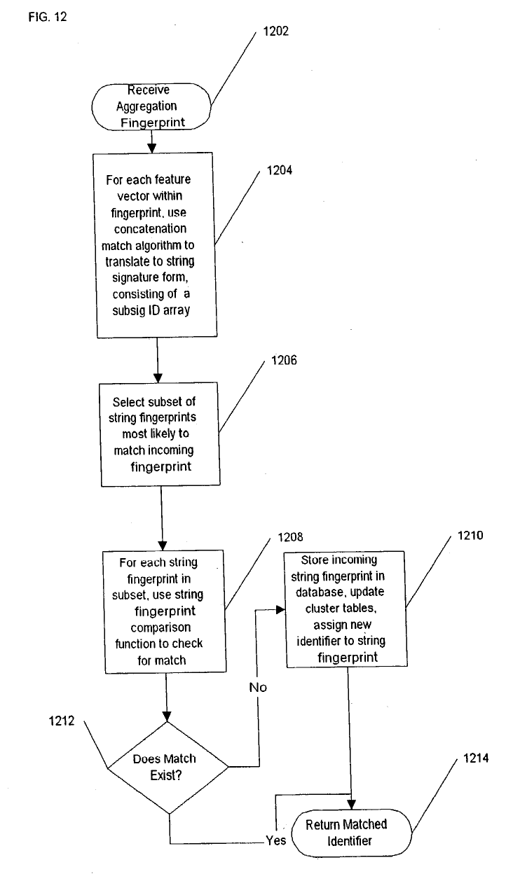

FIG. 12 illustrates the process of resolving of an aggregation type fingerprint, according to the invention. This process is essentially a two level process. After receiving an aggregation fingerprint at step 1202. The individual feature vectors within the aggregation fingerprint are resolved at step 1204, using essentially the same process as the concatenation fingerprint as described above, with the modification that instead of returning a GUID, the individual identifiers return a subsig ID. After all the aggregated feature vectors within the fingerprint are resolved, a string fingerprint, consisting of an array of subsig ID is formed. This format allows for the recognition of signal patterns within a larger signal stream, as well as the detection of a signal that has been reversed. At step 1206, a subset of the string fingerprint of which the incoming feature vector is most likely to be a member is determined. An exemplary embodiment of this determination includes: loading an occurrence rate of each subsig ID in the string fingerprint; subdividing the incoming string fingerprint into smaller chunks, such as the subsigs which preferably correspond to 10 seconds of a signal; and determining which subsig ID within the smaller chunk of subsigs has the lowest occurrence rate of all the reference feature vectors. Then, the reference string fingerprints which share that subsig ID are returned.

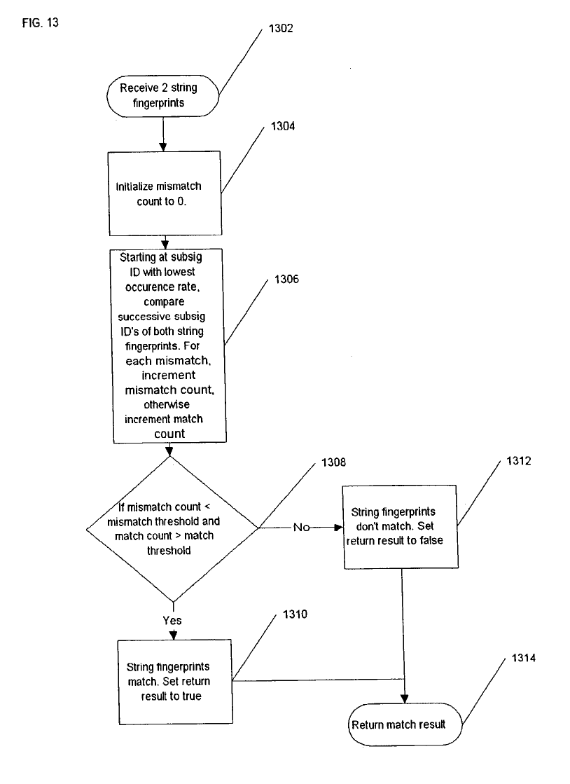

At step 1208, for each string fingerprint in the subset, a string fingerprint comparison function is used to determine if there is a match with the incoming string signature. Preferably, a run length match is performed. Further, it is preferred that the process illustrated in FIG. 13 be utilized to determine the matches. The number of matches and mismatches between the reference string fingerprint and the incoming fingerprint are stored. This is used instead of summed distances, because several consecutive mismatches should trigger a mismatch, since that indicates a strong difference in the signals between two fingerprints. If the match vs. mismatch rate crosses a predefined threshold, a match is recognized as existing.

At step 1210, if a match does not exist, the incoming fingerprint is stored in the file fingerprint database at step 1212. Otherwise, the process proceeds to step 1214, wherein an identifier associated with the matched string fingerprint is returned.

It should be appreciated that rather than storing the incoming fingerprint in the file fingerprint database at step 1212, the process could instead simply return a “no match” indication.

FIG. 13 illustrates a preferred process for determining if two string fingerprints match. This process may be used for example in step 1208 of FIG. 12. At step 1302, first and second string fingerprints are received. At step 1304, a mismatch count is initialized to zero. Starting with the subsig ID having the lowest occurrence rate, the process continues at step 1306 by comparing successive subsig ID's of both string fingerprints. For each mismatch, the mismatch count is incremented, otherwise, a match count is incremented.

At step 1308, it is determined if the mismatch count is less than a mismatch threshold and if the match count is greater than a match threshold. If so, there is a match and a return result flag is set to true at step 1310. Otherwise, there is no match and the return result flag is set to false at step 1312. The mismatch and match thresholds are preferably predetermined, but may be dynamic. At step 1314, the match result is returned.

Additional variants on this match routine include searching forwards and backwards for matches, so as to detect reversed signals, and accepting a continuous stream of aggregation feature vectors, storing a trailing window, such as 30 seconds of signal, and only returning a GUID when a match is finally detected, advancing the search window as more fingerprint subsigs are submitted to the server. This last variant is particularly useful for a streaming situation, where the start and stop points of the signal to be identified are unknown.

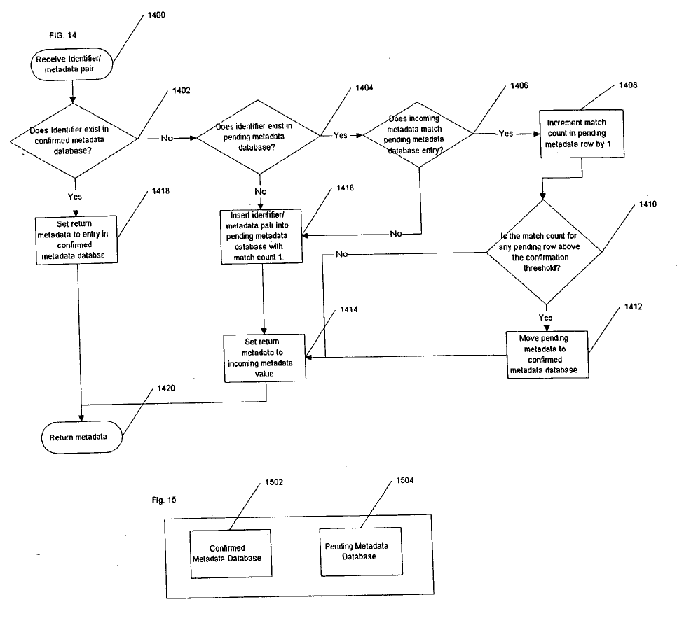

With reference to FIG. 14, a meta-cleansing process according to the present invention is illustrated. At step 1402, an identifier and metadata for a fingerprint that has been matched with a reference fingerprint is received. At 1404 it is determined if the identifier exist in a confirmed metadata database. The confirmed metadata database preferably includes the identifiers of any references fingerprints in a system database that the subject fingerprint was originally compared against. If the does exist in the confirmed metadata database, then the process proceeds to step 1420, described below.

If the identifier does not exist in the confirmed metadata database 1502, as determined at step 1404, then the process proceeds to step 1406, wherein it is determined if the identifier exists in a pending metadata database 1504. This database is comprised of rows containing an identifier, a metadata set, and a match count, indexed by the identifier. If no row exists containing the incoming identifier, the process proceeds to step 1408. Otherwise, the process proceeds to step 1416, described below.

At step 1408, it is determined if the incoming metadata for the matched fingerprint match the pending metadata database entry. If so, a match count for that entry in the pending metadata is incremented by one at step 1410. Otherwise the process proceeds to step 1416, described below.

After step 1410, it is determined, at step 1412, whether the match count exceeds a confirmation threshold. Preferably, the confirmation threshold is predetermined. If the threshold is exceeded by the match count, then at step 1414, the pending metadata database entry to the corresponding entry in the metadata database. The process then proceeds to step 1418.

At step 1416, the identifier and metadata for the matched file are inserted as an entry into the pending metadata database with a corresponding match count of one.

At step 1418, it is identified that the incoming metadata value will be returned from the process.

If at step 1420, it is identified that the metadata value in the confirmed metadata database will be returned from the process.

After steps 1418 and 1420, the process proceeds to step 1422, wherein the applicable metadata value is returned or outputted.

FIG. 15, schematically illustrates an exemplary database collection 1500 that is used with the meta-cleansing process according to the present invention. The database collection includes a confirmed metadata database 1502 and a pending metadata database 1504 as referenced above in FIG. 14. The confirmed metadata database is comprised of an identifier field index, mapped to a metadata row, and optionally a confidence score. The pending metadata database is comprised of an identifier field index, mapped to metadata rows, with each row additionally containing a match count field.

One example of how the meta-cleansing process according to the invention is utilized is illustrated in the following example. Suppose an Internet user downloads a file labeled as song A of artist X. A matching system, for example a system that utilizes the fingerprint resolution process(es) described herein, determines that the file matches a reference file labeled as song B of artist Y. Thus the user's label and the reference label do not match. The system label would then be modified if appropriate (meaning if the confirmation threshold described above is satisfied). For example, the database may indicate that the most recent five downloads have labeled this as song A of artist X. The meta-cleansing process according to this invention would then change the stored data such that the reference label corresponding to the file now is song A of artist X.

While this invention has been described in conjunction with the specific embodiments outlined above, it is evident that many alternatives, modifications and variations will be apparent to those skilled in the art. Accordingly, the embodiments of the invention, as set forth above, are intended to be illustrative, but not limiting. Various changes may be made without departing from the spirit and scope of this invention.

What is claimed is:

1. A method for identifying a fingerprint for a data file, comprising:
receiving the fingerprint having a at least one feature vector developed from the data file;
determining a subset of reference fingerprints from a database of reference fingerprints having at least one feature vector developed from corresponding data files, the subset being a set of the reference fingerprints of which the fingerprint is likely to be a member and being based on the at least one feature vector of the fingerprint and the reference fingerprints; and
determining if the fingerprint matches one of the reference fingerprints in the subset based on a comparison of the reference fingerprint feature vectors in the subset and the at least one feature vector of the fingerprint.

2. A method as recited in claim 1, wherein determining the subset of the reference fingerprints is an iterative process.

3. A method as recited in claim 1, wherein the iterative process of finding a subset includes determining a set of reference fingerprints of the plurality of fingerprints that are nearest neighbors of the fingerprint.

4. A method as recited in claim 3, wherein the nearest neighbors are determined using hash index on the reference fingerprints.

5. A method as recited in claim 1, wherein the determining if there is a match includes determining whether the distance between any of the feature vectors of the reference fingerprints in the subset and the at least one feature vector of the fingerprint is within a predetermined match distance threshold.

6. A method as recited in claim 1, further comprising selecting a feature weight bank based on the similarity of the fingerprint and reference feature class vectors and wherein the selected feature weight bank is used in determining the subset of reference fingerprints.

7. A method as recited in claim 1, wherein the feature vectors of the fingerprint are based on a non-overlapping time frame sampling of the data file.

8. A method as recited in claim 1, further comprising storing the fingerprint for the data file upon determining that there is no match between the fingerprint and the reference fingerprints.

9. A method as recited in claim 1, further comprising, upon determining that the fingerprint matches one of the reference fingerprints, outputting a file identification for the corresponding file of the matched reference fingerprint.

10. A method as recited in claim 9, wherein the file identification for the corresponding file of the matched reference fingerprint is modified if a different confirmed identification exits for the corresponding file of the matched reference fingerprint.

11. A method as recited in claim 1, wherein the fingerprint is a concatenation type fingerprint.

12. A method as recited in claim 1, wherein the data file is an audio file.

13. A method of identifying a fingerprint for a data file, comprising:
receiving the fingerprint having a plurality of feature vectors sampled from a data file over a series of time;
determining a subset of reference fingerprints from a database of reference fingerprints having a plurality of feature vectors sampled from their respective data files over a series of time, the subset being a set of reference fingerprints of which the fingerprint is likely to be a member and being based on the rarity of the feature vectors of the reference fingerprints; and
determining if the fingerprint matches one of the reference fingerprints in the subset.

14. A method as recited in claim 13, wherein finding a subset of file fingerprints includes determining the rarest of the feature vectors of the file fingerprints.

15. A method as recited in claim 14, wherein the fingerprint is an aggregation type fingerprint.

16. A method as recited in claim 13, wherein determining the subset of the reference fingerprints is an iterative process.

17. A method as recited in claim 13, wherein the iterative process of finding a subset includes determining a set of reference fingerprints of the plurality of fingerprints that are nearest neighbors of the fingerprint.

18. A method as recited in claim 17, wherein the nearest neighbors are determined using hash index on the reference fingerprints.

19. A method as recited in claim 13, wherein the determining if there is a match includes determining whether the distance between any of the feature vectors of the reference fingerprints in the subset and the at least one feature vector of the fingerprint is within a predetermined match distance threshold.

20. A method as recited in claim 13, further comprising selecting a feature weight bank based on the similarity of the fingerprint and reference feature class vectors and wherein the feature weight bank is used in determining the subset of reference fingerprints.

21. A method as recited in claim 13, wherein the feature vectors of the fingerprint are based on a non-overlapping time frame sampling of the data file.

22. A method as recited in claim 13, further comprising storing the fingerprint for the data file upon determining that there is no match between the fingerprint and the reference fingerprints.

23. A method as recited in claim 13, further comprising, upon determining that the fingerprint matches one of the reference fingerprints, outputting a file identification for the corresponding file of the matched reference fingerprint.

24. A method as recited in claim 23, wherein the file identification for the corresponding file of the matched reference fingerprint is modified if a different confirmed identification exits for the corresponding file of the matched reference fingerprint.

25. A method as recited in claim 13, wherein the data file is an audio file.

26. A method for updating a reference fingerprint database, comprising:
receiving a fingerprint for a data file;
determining if the fingerprint matches one of a plurality of reference fingerprints; and
upon the determining step revealing no match, updating the reference fingerprint database to include the fingerprint.

27. A method as recited in claim 26, wherein the data file is an audio file.

28. A method as recited in claim 26, wherein the fingerprint is generated from an audio portion of the data file.

29. A method determining a fingerprint for a digital file, comprising:
receiving the digital file;
accessing the digital file over time to generate a sampling; and
determining at least one feature of the digital file based on the sampling, wherein the at least one feature includes at least one of:
a ratio of a mean of the absolute value of the sampling to root-mean-square average of the sampling;
spectral domain features of the sampling;
a statistical summary of the normalized spectral domain features;
Haar wavelets of the sampling;
a zero crossing mean of the sampling;
a beat tracking of the sampling; and
a mean energy delta of the sampling.

30. A method as recited in claim 29, wherein the at least one feature includes a ratio of a mean of the absolute value of the sampling to root-mean-square average of the sampling, spectral domain features of the sampling, a statistical summary of the normalized spectral domain features, and Haar wavelets of the sampling.

31. A method as recited in claim 29, wherein sampling includes generating time slices and determining the at least one feature includes determining at least one feature for each of the time slices.

32. A method as recited in claim 30, wherein sampling includes generating time slices and determining the at least one feature includes determining at least one feature for each of the time slices.

33. A method as recited in claim 29, wherein the data file is an audio file.

34. A method of identifying digital files, comprising:
accessing a digital file;
determining a fingerprint for the digital file, the fingerprint representing at least one feature of the digital file;
comparing the fingerprint to reference fingerprints, the reference fingerprints uniquely identifying a corresponding digital file having a corresponding unique identifier; and
upon the comparing revealing a match between the fingerprint and one of the reference fingerprints, outputting the corresponding unique identifier for the corresponding digital file of the one of the reference fingerprints that matches the fingerprint.

35. A method as recited in claim 34, further comprising generating a unique identifier for the digital file upon the comparing revealing no match.

36. A method as recited in claim 35, wherein the digital file is an audio file.
